(19) United States
(12) Patent Application Publication
(10) Pub. No.: US 2023/0102390 A1
(43) Pub. Date: Mar. 30, 2023

(54) NON-AQUEOUS ELECTROLYTE AND LITHIUM-ION SECONDARY BATTERY

(71) Applicant: TDK Corporation, Tokyo (JP)

(72) Inventors: Kazuki MATSUSHITA, Tokyo (JP); Yuji YAMAMOTO, Tokyo (JP); Takashi MORI, Tokyo (JP)

(73) Assignee: TDK Corporation, Tokyo (JP)

(21) Appl. No.: 17/903,069

(22) Filed: Sep. 6, 2022

(30) Foreign Application Priority Data
Sep. 17, 2021 (JP) 2021-152098

(51) Int. Cl. H01M 10/0567; H01M 10/0569; H01M 10/0568

(52) U.S. Cl. CPC H01M 10/0567; H01M 10/0569; H01M 10/0568; H01M 10/0525

(57) ABSTRACT

This non-aqueous electrolyte may include: a compound represented by Chemical Formula (1).

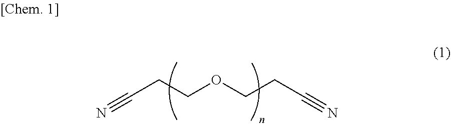

wherein a repeating number n of a unit structure may be an integer in a range of 1 to 7, inclusive.

### CROSS-REFERENCE TO RELATED APPLICATION

Priority is claimed to Japanese Patent Application No. 2021-152098 filed on Sep. 17, 2021, the content of which is incorporated herein by reference in its entirety.

### BACKGROUND

The present disclosure relates to a non-aqueous electrolyte and a lithium-ion secondary battery.

Lithium-ion secondary batteries are also widely used as power sources for mobile devices such as mobile phone and laptop computers and hybrid cars.

Lithium-ion secondary batteries with a high energy density are required along with the increase in the amount of batteries used. Increase in capacity of positive electrodes is one means for increasing the energy density of lithium-ion secondary batteries.

Patent Document 1 discloses a lithium-ion secondary battery that can suppress gas production at a high temperature to realize increase in energy density.
[Patent Document 1] Published Japanese Translation No. 2016-526772 of the PCT International Publication

### SUMMARY

A positive electrode of a high capacity lithium-ion secondary battery may have a high potential. A non-aqueous electrolyte, which is less likely to decompose even at a high potential, is required for stable operation of a lithium-ion secondary battery.

The present disclosure has been made in consideration of the above-described problem or other problems, and one non-limiting aspect of the present disclosure is to provide a non-aqueous electrolyte and a lithium-ion secondary battery that can be stably used even at a high potential.

Some embodiments of the present disclosure provide the following means to solve the above-described problems.

(1) A non-aqueous electrolyte according to a first aspect includes: a compound represented by Chemical Formula (1) below.

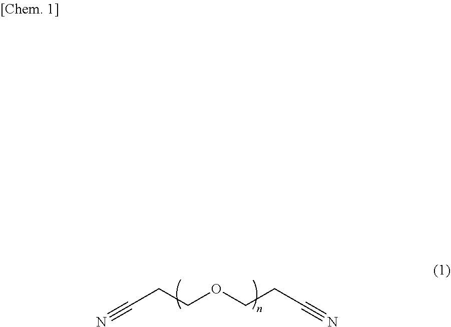

(2) In Chemical Formula (1) of the non-aqueous electrolyte according to the above-described aspect, a repeating number n of a unit structure may be 1 to 4.

(3) In the non-aqueous electrolyte according to the above-described aspect, an amount of the compound represented by Chemical Formula (1) may be 0.1 parts by mass to 10 parts by mass.

(4) A lithium-ion secondary battery according to a second aspect includes: the non-aqueous electrolyte according to the above-described aspect; a positive electrode: a negative electrode; and a separator between the positive electrode and the negative electrode.

(5) In the lithium-ion secondary battery according to the above-described aspect, the positive electrode may have a positive electrode active material, and the positive electrode active material may contain any one selected from the group consisting of nickel, cobalt, manganese, and aluminum.

(6) In the lithium-ion secondary battery according to the above-described aspect, the negative electrode may have a negative electrode active material, and the negative electrode active material may be a carbon material or a substance that can be alloyed with lithium.

(7) In the lithium-ion secondary battery according to the above-described aspect, the substance may include silicon, tin, zinc, lead, and/or antimony.

The non-aqueous electrolyte and the lithium-ion secondary battery according to the above-described aspects can be used stably even at a high potential.

### BRIEF DESCRIPTION OF THE DRAWING

FIG. 1 is a schematic diagram of a lithium-ion secondary battery according to a first embodiment.

### DETAILED DESCRIPTION

Hereinafter, the embodiment will be described in detail with reference to the accompanying drawing as appropriate. In the drawings used in the following description, a part that becomes a feature is sometimes enlarged for convenience in order to allow the feature to be easily understood, and the dimensional ratios of each constituent element and the like are sometimes different from the actual ones. The materials, dimensions, and the like provided in the following description are merely exemplary examples, and the present disclosure is not limited thereto and can be implemented by being appropriately modified within the range that does not change the gist thereof.

### “Lithium-Ion Secondary Battery”

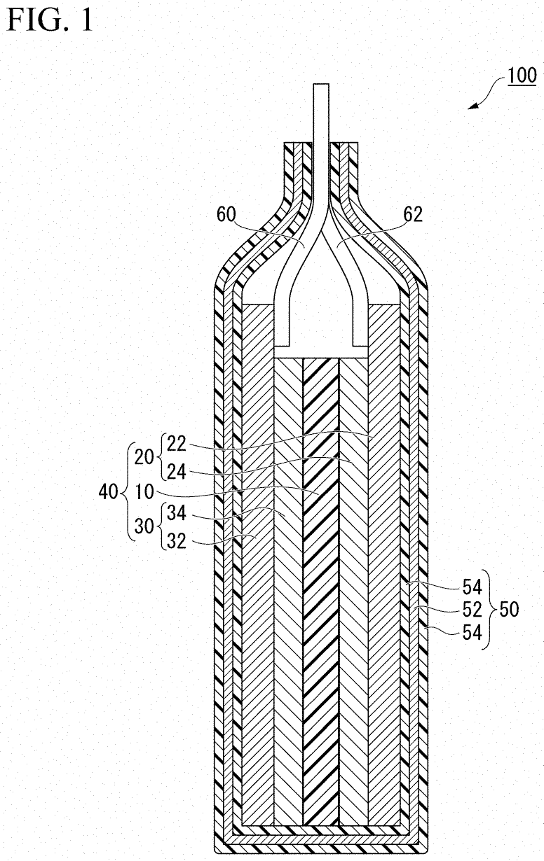

FIG. 1 is a schematic diagram of a lithium-ion secondary battery according to a first embodiment. A lithium-ion secondary battery 100 shown in FIG. 1 may include a power generation element 40, an exterior body 50, and a non-aqueous electrolyte. The exterior body 50 covers the periphery of the power generation element 40. The power generation element 40 is connected to outside via a pair of terminals 60 and 62 connected to the power generation element 40. The non-aqueous electrolyte is housed in the exterior body 50.

### (Power Generation Element)

The power generation element 40 may include a separator 10, a positive electrode 20, and a negative electrode 30.

### <Positive Electrode>

The positive electrode 20 has a positive electrode current collector 22 and a positive electrode active material layer 24, for example. The positive electrode active material layer 24 is in contact with at least one surface of the positive electrode current collector 22.

### [Positive Electrode Current Collector]

The positive electrode current collector 22 is, for example, a conductive sheet material. The positive electrode current collector 22 is, for example, a thin metal sheet such as aluminum, copper, nickel, titanium, or stainless steel. Aluminum, which is lightweight, is suitably used for the positive electrode current collector 22. The average thickness of the positive electrode current collector 22 is, for example, 10 μm to 30 μm.

### [Positive Electrode Active Material Layer]

The positive electrode active material layer 24 contains, for example, a positive electrode active material. The positive electrode active material layer 24 may contain a conductive auxiliary agent and a binder as necessary.

The positive electrode active material may include an electrode active material capable of reversibly advancing storage and release of lithium ions, desorption and insertion (intercalation) of lithium ions, or doping and dedoping of lithium ions and counter anions.

The positive electrode active material is, for example, a composite metal oxide. The composite metal oxide is, for example, lithium cobalt oxide (LiCoO₂), lithium nickel oxide (LiNiO₂), lithium manganese oxide (LiMnO₂), lithium manganese spinel (LiMn₂O₄), a compound represented by general formula: LiNiₓCo_{y}Mn_{z}MₐO₂ (in the general formula, x+y+z+a=1, 0≤x<1, 0≤y<1, 0≤z<1, 0≤a<1, and M is one or more kinds of elements selected from Al, Mg, Nb, Ti, Cu, Zn, or Cr), a lithium vanadium compound (LiV₂O₅), olivine-type LiMPO₄ (where M represents VO or one or more kinds of elements selected from Co, Ni, Mn, Fe, Mg, Nb, Ti, Al, and Zr), lithium titanium oxide (Li₄Ti₅O₁₂), or LiNiₓCo_{y}Al_{z}O₂ (0.9<x+y+z<1.1). The positive electrode active material may be an organic substance. For example, the positive electrode active material may be polyacetylene, polyaniline, polypyrrole, polythiophene, or polyacene.

The positive electrode active material may contain any one selected from the group consisting of nickel, cobalt, manganese, and aluminium. The positive electrode active material may be a ternary compound containing any one selected from the group consisting of nickel, cobalt, manganese, and aluminum. Lithium nickel cobalt manganese (NCM) and lithium nickel cobalt aluminate (NCA) are examples of ternary compounds. The temary compounds can be used even at a high potential.

The positive electrode active material may be a lithium-free material. The lithium-free material is, for example, FeF₃, a conjugated polymer containing an organic conductive substance, a Chevrel phase compound, a transition metal chalcogenide, vanadium oxide, and niobium oxide. As the lithium-free material, only one material may be used, or a plurality of materials may be used in combination. In a case where the positive electrode active material is a lithium-free material, discharge is performed first, for example. Lithium is inserted into a positive electrode active material through discharge. Lithium may be chemically or electrochemically pre-doped into a lithium-free material which is a positive electrode active material.

A conductive auxiliary agent enhances electron conductivity between the positive electrode active materials. The conductive auxiliary agent is, for example, carbon powder, a carbon nanotube, a carbon material, a metal fine powder, a mixture of a carbon material and a metal fine powder, and a conductive oxide. The carbon powder is, for example, carbon black, acetylene black, and ketjen black. The fine metal powder is, for example, a powder of copper, nickel, stainless steel, iron, and the like.

The amount of a conductive auxiliary agent in the positive electrode active material layer 24 is not particularly limited. For example, the amount of a conductive auxiliary agent with respect to the total mass of a positive electrode active material, the conductive auxiliary agent, and a binder is 0.5 mass % to 20 mass % and preferably 1 mass % to 5 mass %.

The binder in the positive electrode active material layer 24 binds the positive electrode active materials to each other. Well-known binders can be used as the binder. In addition, as the binder, the same binders as those used in a negative electrode active material layer 34 to be described below may be used. A binder which does not dissolve in an electrolyte and has oxidation resistance and adhesiveness is preferable as the binder. The binder is, for example, a fluororesin. The binder is, for example, poly vinylidene fluoride (PVDF), polytetrafluoroethylene (PTFE), polyamide (PA), polyimide (PT), polyamideimide (PAI), polybenzimidazole (PBI), polyethersulfone (PES), polyacrylic acid and a copolymer thereof, metal ion cross-linked products of polyacrylic acid and a copolymer thereof, polypropylene (PP) or polyethylene (PE) grafted with maleic anhydride, and a mixture thereof. PVDF is particularly preferable as a binder used for a positive electrode active material layer.

The amount of the binder in the positive electrode active material layer 24 is not particularly limited. For example, the amount of the binder with respect to the total mass of the positive electrode active material, the conductive auxiliary agent, and the binder is 1 mass % to 15 mass % and preferably 1.5 mass % to 5 mass %. When the amount of a binder is too low, the adhesive strength of the positive electrode 20 is weakened. When the amount of the binder is too high, the energy density of the lithium-ion secondary battery 100 is lowered because the binder is electrochemically inactive and does not contribute to the discharging capacity.

### <Negative Electrode>

The negative electrode 30 has, for example, a negative electrode current collector 32 and a negative electrode active material layer 34. The negative electrode active material layer 34 is formed on at least one surface of the negative electrode current collector 32.

### [Negative Electrode Current Collector]

The negative electrode current collector 32 is, for example, a conductive sheet material. The same ones as for the positive electrode current collector 22 can be used for the negative electrode current collector 32.

### [Negative Electrode Active Material Layer]

The negative electrode active material layer 34 contains, for example, a negative electrode active material. The negative electrode active material layer 34 may contain a conductive auxiliary agent and a binder as necessary.

The negative electrode active material may be a compound capable of storing and releasing ions, and negative electrode active materials used in well-known lithium-ion secondary batteries can be used. The negative electrode active material is, for example, metallic lithium, a lithium alloy, a carbon material, and a substance that can be alloyed with lithium. The carbon material is, for example, graphite (natural graphite and artificial graphite, carbon nanotubes, non-graphitizing carbon, easily graphitized carbon, and low temperature calcined carbon which can store and release ions. The substance that can be alloyed with lithium includes silicon, tin, zinc, lead, and antimony. The substance that can be alloyed with lithium may be, for example, an elemental metal thereof or an oxide or an alloy containing these elements. In addition, the substance that can be alloyed with lithium may be a complex in which at least a part of the surface of the substance is covered with a conductive material (for example, a carbon material) or the like.

The negative electrode active material layer 34 may contain, for example, lithium as described above. The lithium may be metallic lithium or a lithium alloy. The negative electrode active material layer 34 may be metallic lithium or a lithium alloy. The lithium alloy is, for example, an alloy of lithium and one or more kinds of elements selected from the group consisting of Si, Sn, C, Pt, Ir, Ni, Cu, Ti, Na, K, Rb, Cs, Fr, Be, Mg, Ca, Sr, Sb, Pb, In, Zn, Ba, Ra, Ge, and Al. As an example, in a case where a negative electrode active material is metal lithium, the negative electrode 30 is sometimes referred to as a Li negative electrode. The negative electrode active material layer 34 may be a lithium sheet.

The negative electrode 30 may be only the negative electrode current collector 32 without the negative electrode active material layer 34 being included during produce. If the lithium-ion secondary battery 100 is charged, metallic lithium precipitates on the surface of the negative electrode current collector 32. Metallic lithium is elemental lithium in which lithium ions precipitate and functions as the negative electrode active material layer 34.

The same conductive auxiliary agent and binder as those of the positive electrode 20 can be used. The binder in the negative electrode 30 may be, for example, cellulose, styrene-butadiene rubber, ethylene-propylene rubber, a polyimide resin, a polyamideimide resin, or an acrylic resin in addition to those provided as an exemplary example for the positive electrode 20. Cellulose may be, for example, carboxymethyl cellulose (CMC).

### <Separator>

The separator 10 is sandwiched between the positive electrode 20 and the negative electrode 30. The separator 10 separates the positive electrode 20 and the negative electrode 30 from each other and prevents a short circuit between the positive electrode 20 and the negative electrode 30. The separator 10 extends in-plane along the positive electrode 20 and the negative electrode 30. Lithium ions can pass through the separator 10.

The separator 10 has, for example, an electrically insulating porous structure. The separator 10 is, for example, a single-layer body or a laminated body including a polyolefin film. The separator 10 may be a stretched film of a mixture of polyethylene, polypropylene, and the like. The separator 10 may be a fibrous non-woven fabric made of at least one constituent material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide solid electrolyte, or a sulfide solid electrolyte. The separator 10 may be an inorganic coated separator. The inorganic coated separator is obtained by coating the surface of the above-described film with a mixture of a resin such as PVDF or CMC and an inorganic substance such as alumina or silica. The inorganic coated separator has an excellent heat resistance and suppresses precipitation of transition metals eluted from a positive electrode on the surface of a negative electrode.

### <Non-Aqueous Electrolyte>

A non-aqueous electrolyte is enclosed within a volume defined by the exterior body 50 and impregnated into the power generation element 40. The non-aqueous electrolyte contains, for example, a non-aqueous solvent and an electrolytic salt. The electrolytic salt is dissolved in the non-aqueous solvent.

This non-aqueous electrolyte may include a compound represented by Chemical Formula (1) below.

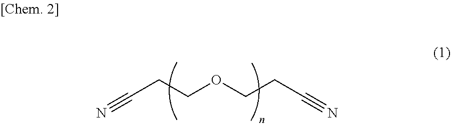

This compound has a higher highest electron occupied orbital (HOMO) level than a general carbonate solvent. For this reason, this compound is oxidized and decomposes prior to a carbonate compound. Decomposition products oxidized and decomposed from this compound during initial charge may form a protective layer on the surface of a positive electrode active material. This protective layer may suppress decomposition of an electrolyte even at a high potential of 4.5 V or higher, for example.

In addition, this compound may form complex ions with metal cations eluted from the positive electrode active material. In other words, metal cations eluted from the positive electrode active material may be captured by this compound. The metal cations are one of the causes of decomposing an SEI film of the surface of a negative electrode active material, and causes deterioration of the lithium-ion secondary battery 100. In addition, the precipitation of transition metals in a negative electrode is one of the causes of an internal short circuit. The internal short circuit and the deterioration of the lithium-ion secondary battery 100 can be prevented by this compound captures metal cations.

In Chemical Formula (1), a repeating number n of a unit structure is, for example, 1 to 4, inclusive. When the repeating number n of a unit structure is within the range, generation of gases from the positive electrode 20 can be suppressed and the cycle characteristics of the lithium-ion secondary battery 100 improve. The compound represented by Chemical Formula (1) in the non-aqueous electrolyte may all have a unit structure with the same repeating number n, or may have a mixture of unit structures with different repeating numbers n.

The abundance ratio of the compound represented by Chemical Formula (1) in the non-aqueous electrolyte is, for example, 0.1 parts by mass to 10 parts by mass when the entire non-aqueous electrolyte is 100 parts by mass. When the ratio of the compound is within this range, generation of gases from the positive electrode 20 can be suppressed and the cycle characteristics of the lithium-ion secondary battery 100 improve.

The non-aqueous electrolyte may contain another organic solvent in addition to the compound represented by Chemical Formula (1). Examples of the other organic solvent include an aprotic organic solvent. For example, an electrolyte may contain cyclic carbonate, chain carbonate, and ethers. The cyclic carbonate compound is, for example, ethylene carbonate (EC) and propylene carbonate (PC). The chain carbonate compound is, for example, diethyl carbonate (DEC), ethyl methyl carbonate (EMC), and dimethyl carbonate (DMC). The cyclic ester compound is, for example, γ-butyrolactone. The chain ester compound is, for example, propyl propionate, ethyl propionate, and ethyl acetate. Cyclic carbonate has a high dielectric constant, and chain carbonate has a low viscosity. Since an electrolyte contains both cyclic carbonate and chain carbonate, battery capacity can be improved without hindering movement of electrolyte ions.

An electrolytic salt is, for example, a lithium salt. An electrolyte is, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, and LiN(FSO₂)₂.

Lithium salts may be used alone or in combination of two or more thereof. An electrolyte preferably contains LiPF₆ from the viewpoint of the degree of ionization.

### <Exterior Body>

The exterior body 50 seals the power generation element 40 and the non-aqueous electrolyte therein. The exterior body 50 restrains the non-aqueous electrolyte from leaking to the outside, and water and the like from invading into the lithium-ion secondary battery 100 from the outside.

The exterior body 50 has, for example, a metal foil 52 and a resin layer 54 laminated on each surface of the metal foil 52, as shown in FIG. 1. The exterior body 50 is a metal laminated film obtained by coating both sides of the metal foil 52 with polymer films (resin layers 54).

For example, aluminum foil can be used as the metal foil 52. A polymer film such as polypropylene can be used for the resin layer 54. The material constituting the resin layer 54 may be different between inside and outside the resin layer. For example, polymers, such as polyethylene terephthalate (PET) and polyamide (PA), having a high melting point can be used as the outer material, and polyethylene (PE), polypropylene (PP), and the like can be used as the material of the inner polymer film.

### <Terminal>

Terminals 60 and 62 are respectively connected to the negative electrode 30 and the positive electrode 20. The terminal 60 connected to the negative electrode 30 is a negative electrode terminal, and the terminal 62 connected to the positive electrode 20 is a positive electrode terminal. The terminals 60 and 62 are responsible for electrical connection with outside. The terminals 60 and 62 are made of a conductive material such as aluminum, nickel, and copper. The connection method may be welding or screwing. The terminals 60 and 62 are preferably protected by insulating tape to prevent a short circuit.

### “Method for Producing Lithium-Ion Secondary Battery”

The lithium-ion secondary battery 100 is produced by preparing each of the negative electrode 30, the positive electrode 20, the separator 10, an electrolyte, and an exterior body 50 and assembling them. Hereinafter, an example of a method for producing the lithium-ion secondary battery 100 will be described.

The negative electrode 30 is produced by, for example, performing a slurry production step, an electrode coating step, a drying step, a rolling step in this order.

The slurry production step is a step of mixing a negative electrode active material, a binder, a conductive auxiliary agent, and a solvent with each other to produce a slurry. The solvent is, for example, water and N-methyl-2-pyrrolidone. The composition ratio of the negative electrode active material, the conductive material, and the binder is preferably 70 wt % to 100 wt %:0 wt % to 10 wt %:0 wt % to 20 wt % by mass ratio. These mass ratios are adjusted to be 100 wt % in total.

The negative electrode active material may be a composite of active material particles and a conductive material mixed with each other by applying a shear force. When the mixing is performed while applying a shear force to the extent that the properties of the active material particles are not changed, the surfaces of the active material particles are coated with the conductive material. In addition, the particle size of the negative electrode active material can be adjusted according to the degree of mixing. In addition, the produced negative electrode active material may be sieved to make the particle size uniform.

The electrode coating step is a step of coating the surface of the negative electrode current collector 32 with the slurry. The coating method with a slurry is not particularly limited. For example, a slit-die coating method and a doctor blade method can be used as the coating method with the slurry.

The drying step is a step of removing a solvent from a slurry. For example, the negative electrode current collector 32 coated with a slurry is dried in an atmosphere of 80° C. to 150° C. As the slurry dries, the negative electrode active material layer 34 is formed on the negative electrode current collector 32.

The rolling step is performed as necessary. The rolling step is a step of applying pressure to the negative electrode active material layer 34 to adjust the density of the negative electrode active material layer 34. The rolling step is performed by a roll press device or the like, for example.

The positive electrode 20 can be produced in the same procedure as that of the negative electrode 30. As the separator 10 and the exterior body 50, commercially available ones can be used.

Subsequently, the positive electrode 20 and the negative electrode 30 produced are laminated so that the separator 10 is located therebetween to produce the power generation element 40. In a case where the power generation element 40 is a wound body, the positive electrode 20, the negative electrode 30, and the separator 10 are wound around one end side of the positive electrode, the negative electrode, and the separator as an axis.

Finally, the power generation element 40 is enclosed in the exterior body 50. A non-aqueous electrolyte is injected into the exterior body 50. The non-aqueous electrolyte is impregnated into the power generation element 40 by performing pressure reduction, heating, and the like after injecting the non-aqueous electrolyte. B The exterior body 50 is sealed by applying heat or the like, and thereby the lithium-ion secondary battery 100 can be obtained. The power generation element 40 may be impregnated with the non-aqueous electrolyte instead of injecting an electrolyte into the exterior body 50.

The lithium-ion secondary battery 100 according to the first embodiment generates a small amount of gas and has excellent cycle characteristics even when a high voltage of 4.5 V or higher is applied. This is thought because the compound (1) contained in the non-aqueous electrolyte decomposes prior to a carbonate solvent to form a protective film on the surface of a positive electrode active material and captures metal cations, as described above.

In other words, when the non-aqueous electrolyte contains this compound (1), the lithium-ion secondary battery 100 can be made to have a high potential and a high energy density.

The embodiment of the present disclosure has described in detail above with reference to the drawings. However, the configuration or the like in the above-described embodiment is merely an example, and addition, omission, replacement, and other modifications of the configuration can be made within the scope not departing from the gist of the present disclosure.

### EXAMPLES

### Example 1

One surface of aluminum foil having a thickness of 15 μm was coated with a positive electrode slurry. The positive electrode slurry was produced by mixing a positive electrode active material, a conductive auxiliary agent, a binder, and a solvent with each other.

LiₓCoO₂ was used as the positive electrode active material. Carbon black was used as the conductive auxiliary agent. Poly vinylidene fluoride (PVDF) was used as the binder. N-methyl-2-pyrrolidone was used as the solvent. 97 parts by mass of the positive electrode active material, 1 part by mass of the conductive auxiliary agent, 2 parts by mass of the binder, and 70 parts by mass of the solvent were mixed with each other to produce a positive electrode slurry. The supported amount of the positive electrode active material on a dried positive electrode active material layer was 25 mg/cm. The solvent was removed from the positive electrode slurry in a drying furnace to produce the positive electrode active material layer. The positive electrode active material layer was pressed through roll pressing to produce a positive electrode.

Subsequently, one surface of copper foil having a thickness of 10 μm was coated with a negative electrode slurry. The negative electrode slurry was produced by mixing a negative electrode active material, a conductive auxiliary agent, a binder, and a solvent with each other.

Graphite was used as the negative electrode active material. Carbon black was used as the conductive auxiliary agent. Carboxymethyl cellulose (CMC) or styrene-butadiene rubber (SBR) was used as the binder. The mass ratio of the negative electrode active material, the conductive auxiliary agent, and the binder was 90:5:5. This negative electrode mixture was dispersed in distilled water to produce a negative electrode slurry. Then, one surface of copper foil having a thickness of 10 jam was coated with the negative electrode slurry. The supported amount of the negative electrode active material on a dried negative electrode active material layer was 2.0 mg/cm². The solvent was removed from the negative electrode slurry through drying to produce the negative electrode active material layer.

Subsequently, a non-aqueous electrolyte was produced. Ethylene carbonate and diethyl carbonate were used as a solvent, and the compound represented by Chemical Formula (1) described above (hereinafter, sometimes referred to as an additive) was added. The repeating number n of the repeating unit of the compound represented by Chemical Formula (1) was 1. LiPF₆ was used as an electrolytic salt. The concentration of LiPF₆ was 1 mol/L. The mass ratio of the compound represented by Chemical Formula (1) was 1 mass % with respect to the non-aqueous electrolyte.

### (Produce of Lithium-Ion Secondary Battery for Evaluation)

The negative electrode and the positive electrode produced were laminated via a separator (porous polyethylene sheet) so that the positive electrode active material layer and the negative electrode active material layer face each other to obtain a laminated body. Negative electrode lead made of nickel was attached to the negative electrode of the laminated body. Positive electrode lead made of aluminum was attached to the positive electrode of the laminated body. The positive electrode lead and the negative electrode lead were welded using an ultrasonic welder. This laminated body was inserted into an exterior body of an aluminum laminated film, and the exterior body was heat-sealed except for one peripheral portion to form a closed part. Then, finally, after the above-described electrolyte was injected into the exterior body, the remaining one portion was sealed through heat-sealing while reducing the pressure using a vacuum sealer to produce a lithium-ion secondary battery.

(Measurement of Capacity Retention Rate after 100 Cycles)

The cycle characteristics of the lithium-ion secondary battery were measured. The measurement of the cycle characteristics was performed using a secondary battery charge/discharge test device (produced by HOKUTO DENKO CORPORATION).

Charge was performed until the battery voltage reached 4.5 V through constant current charge with a charge rate of 1.0 C (a current value at which charge was completed in 1 hour when the constant current charge was performed at 25° C.), and discharge was performed until the battery voltage reached 3.0 V through constant current discharge with a discharge rate of 1.0 C. The discharge capacity after the completion of the charge and discharge was detected, and a battery capacity Q₁ before a cycle test was obtained.

A secondary battery charge/discharge test device was used again to charge the battery from which the battery capacity Q₁ was obtained as above until the battery voltage reached 4.5 V through constant current charge with a charge rate of 1.0 C and to discharge the battery until the battery voltage reached 3.0 V through constant current discharge with a discharge rate of 1.0 C. The above-described charge and discharge was counted as one cycle, and 100 cycles of charge and discharge were performed.

Thereafter, the discharge capacity after the completion of 100 cycles of the charge and discharge was detected, and a battery capacity Q₂ after 100 cycles was obtained.

A capacity retention rate E after 100 cycles was obtained from the capacities Q₁ and Q₂ obtained above. The capacity retention rate E is obtained by E=Q₂/Q₁×100. The capacity retention rate of Example 1 was 92%.

### (Measurement of Amount of Gas Generated)

A sample as the same sample whose cycle characteristics were measured was prepared, and the amount of gas generated from the lithium-ion secondary battery was obtained.

The amount (%) of gas generated was obtained by (“volume of battery after storage test”/“volume of battery before storage test”−1)×100. In the storage test, the lithium-ion secondary battery was maintained in a charge state at 4.5 V and held in a constant-temperature tank maintained at 65° C. for 24 hours. The amount of gas generated in Example 1 was 7%.

### Examples 2 to 7

Examples 2 to 7 are different from Example 1 in that the repeating number n of the repeating unit of the compound represented by Chemical Formula (1) was changed. n was set to 2 in Example 2, 3 in Example 3, 4 in Example 4, 5 in Example 5, 6 in Example 6, and 7 in Example 7. The capacity retention rate and the amount of gas generated were obtained while keeping other conditions the same as in Example 1. The results are shown in Table 1.

### Examples 8 to 14

Examples 8 to 14 are different from Example 1 in that the mass ratio of the compound (additive) represented by Chemical Formula (1) to a non-aqueous electrolyte was changed. The amount of the additive was set to 0.05 mass % in Example 8, 0.1 mass % in Example 9, 0.5 mass % in Example 10, 5.0 mass % in Example 11, 10.0 mass % in Example 12, 15.0 mass % in Example 13, and 20.0 mass % in Example 14. The capacity retention rate and the amount of gas generated were obtained while keeping other conditions the same as in Example 1. The results are shown in Table 1.

### Examples 15 and 16

Examples 15 and 16 are different from Example 1 in that the type of the positive electrode active material was changed. LiNi_{1/3}Co_{1/3}Mn_{1/3}O₂(NCM) was used as the positive electrode active material in Example 15. LiNi_{0.85}Co_{0.12}Al_{0.03}O₂ (NCA) was used as the positive electrode active material in Example 16. The capacity retention rate and the amount of gas generated were obtained while keeping other conditions the same as in Example 1. The results are shown in Table 1.

### Examples 17 and 18

Examples 17 and 18 are different from Example 1 in that the type of the negative electrode active material was changed. Silicon was used as the negative electrode active material in Example 17. Silicon oxide was used as the negative electrode active material in Example 18. The capacity retention rate and the amount of gas generated were obtained while keeping other conditions the same as in Example 1 The results are shown in Table 1.

### Examples 19 to 21

Examples 19 to 21 are different from Example 1 in that the charge voltage during the cycle test and the gas generation test was changed. The charge voltage was set to 4.6 V in Example 19. The charge voltage was set to 4.7 V in Example 20. The charge voltage was set to 4.8 V in Example 21. The capacity retention rate and the amount of gas generated were obtained while keeping other conditions the same as in Example 1. The results are shown in Table 1.

### Comparative Example

Comparative Example 1 is different from Example 1 in that the compound represented by Chemical Formula (1) was not added to a non-aqueous electrolyte. The capacity retention rate and the amount of gas generated were obtained while keeping other conditions the same as in Example 1. The results are shown in Table 1.

### Comparative Examples 2 and 3

Comparative Examples 2 and 3 are different from Comparative Example 1 in that the type of the positive electrode active material was changed. LiNi_{1/3}Co_{1/3}Mn_{1/3}O₂ (NCM) was used as the positive electrode active material in Comparative Example 2. LiNi_{0.85}Co_{0.12}Al_{0.03}O₂ (NCA) was used as the positive electrode active material in Comparative Example 3. The capacity retention rate and the amount of gas generated were obtained while keeping other conditions the same as in Comparative Example 1. The results are shown in Table 1.

### Comparative Examples 4 and 5

Comparative Examples 4 and 5 are different from Comparative Example 1 in that the type of the negative electrode active material was changed. Silicon was used as the negative electrode active material in Comparative Example 4. Silicon oxide was used as the negative electrode active material in Comparative Example 5. The capacity retention rate and the amount of gas generated were obtained while keeping other conditions the same as in Comparative Example 1. The results are shown in Table 1.

### Comparative Examples 6 to 8

Comparative Examples 6 to 8 are different from Comparative Example 1 in that the charge voltage during the cycle test and the gas generation test was changed. The charge voltage was set to 4.6 V in Comparative Example 6. The charge voltage was set to 4.7 V in Comparative Example 7. The charge voltage was set to 4.8 V in Comparative Example 8. The capacity retention rate and the amount of gas generated were obtained while keeping other conditions the same as in Comparative Example 1. The results are shown in Table 1.

TABLE 1

| | | | Additive of | | | | |
|---|---|---|---|---|---|---|---|
| | | | Chemical | | | | |
| | | | Formula (1) | | | | |
| | Positive | Negative | | Added | Positive electrode | Amount (%) | Capacity |
| | electrode | electrode | | amount | charge potential | of gas | retention rate |
| | active material | active material | n | (mass %) | (V vs. Li/Li⁺) | generated | (%) |
| Example 1 | LiCoO₂ | Graphite | 1 | 1 | 4.5 V | 7 | 92 |
| Example 2 | LiCoO₂ | Graphite | 2 | 1 | 4.5 V | 5 | 97 |
| Example 3 | LiCoO₂ | Graphite | 3 | 1 | 4.5 V | 7 | 93 |
| Example 4 | LiCoO₂ | Graphite | 4 | 1 | 4.5 V | 9 | 91 |
| Example 5 | LiCoO₂ | Graphite | 5 | 1 | 4.5 V | 18 | 75 |
| Example 6 | LiCoO₂ | Graphite | 6 | 1 | 4.5 V | 19 | 73 |
| Example 7 | LiCoO₂ | Graphite | 7 | 1 | 4.5 V | 20 | 70 |
| Example 8 | LiCoO₂ | Graphite | 2 | 0.05 | 4.5 V | 20 | 82 |
| Example 9 | LiCoO₂ | Graphite | 2 | 0.1 | 4.5 V | 7 | 94 |
| Example 10 | LiCoO₂ | Graphite | 2 | 0.5 | 4.5 V | 6 | 95 |
| Example 11 | LiCoO₂ | Graphite | 2 | 5 | 4.5 V | 6 | 94 |
| Example 12 | LiCoO₂ | Graphite | 2 | 10 | 4.5 V | 7 | 93 |
| Example 13 | LiCoO₂ | Graphite | 2 | 15 | 4.5 V | 17 | 88 |
| Example 14 | LiCoO₂ | Graphite | 2 | 20 | 4.5 V | 19 | 85 |
| Example 15 | NCM | Graphite | 2 | 1 | 4.5 V | 7 | 97 |
| Example 16 | NCA | Graphite | 2 | 1 | 4.5 V | 7 | 95 |
| Example 17 | LiCoO₂ | Si | 2 | 1 | 4.5 V | 10 | 93 |
| Example 18 | LiCoO₂ | Silicon oxide | 2 | 1 | 4.5 V | 8 | 93 |
| Example 19 | LiCoO₂ | Graphite | 2 | 1 | 4.6 V | 7 | 94 |
| Example 20 | LiCoO₂ | Graphite | 2 | 1 | 4.7 V | 8 | 91 |
| Example 21 | LiCoO₂ | Graphite | 2 | 1 | 4.8 V | 9 | 88 |
| Comparative | LiCoO₂ | Graphite | 0 | 0 | 4.5 V | 30 | 60 |
| Example 1 | | | | | | | |
| Comparative | NCM | Graphite | 0 | 0 | 4.5 V | 33 | 55 |
| Example 2 | | | | | | | |
| Comparative | NCA | Graphite | 0 | 0 | 4.5 V | 32 | 57 |
| Example 3 | | | | | | | |
| Comparative | LiCoO₂ | Si | 0 | 0 | 4.5 V | 40 | 50 |
| Example 4 | | | | | | | |
| Comparative | LiCoO₂ | Silicon oxide | 0 | 0 | 4.5 V | 34 | 53 |
| Example 5 | | | | | | | |
| Comparative | LiCoO₂ | Graphite | 0 | 0 | 4.6 V | 33 | 55 |
| Example 6 | | | | | | | |
| Comparative | LiCoO₂ | Graphite | 0 | 0 | 4.7 V | 38 | 51 |
| Example 7 | | | | | | | |
| Comparative | LiCoO₂ | Graphite | 0 | 0 | 4.8 V | 40 | 44 |
| Example 8 | | | | | | | |

It was confirmed from Table 1 that, when the compound represented by Chemical Formula (1) is added to a non-aqueous electrolyte, a small amount of gas is generated and the cycle characteristics improve.

### EXPLANATION OF REFERENCES

10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium-ion secondary battery

What is claimed is:

1. A non-aqueous electrolyte comprising:
a compound represented by Chemical Formula (1): 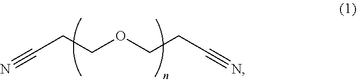
wherein a repeating number n of a unit structure is an integer in a range of 1 to 7, inclusive.

2. The non-aqueous electrolyte according to claim 1,
wherein, in Chemical Formula (1), n is 1 to 4, inclusive.

3. The non-aqueous electrolyte according to claim 1,
wherein an amount of the compound represented by Chemical Formula (1) is 0.1 parts by mass to 10 parts by mass on a basis of an entire non-aqueous electrolyte being 100 parts by mass.

4. A lithium-ion secondary battery comprising:
the non-aqueous electrolyte according to claim 1;
a positive electrode;
a negative electrode; and
a separator between the positive electrode and the negative electrode.

5. The lithium-ion secondary battery according to claim 4,
wherein the positive electrode comprises a positive electrode active material, and
wherein the positive electrode active material contains at least one selected from the group consisting of nickel, cobalt, manganese, and aluminum.

6. The lithium-ion secondary battery according to claim 4,
wherein the negative electrode comprises a negative electrode active material, and
wherein the negative electrode active material is a carbon material or a substance that can be alloyed with lithium.

7. The lithium-ion secondary battery according to claim 6,
wherein the substance includes silicon, tin, zinc, lead, and/or antimony.

8. The non-aqueous electrolyte according to claim 1, further comprising a non-aqueous solvent and an electrolytic salt.

9. The non-aqueous electrolyte according to claim 8, wherein the non-aqueous solvent is an aprotic organic solvent.

10. The non-aqueous electrolyte according to claim 9, wherein the aprotic organic solvent includes cyclic carbonate, chain carbonate, and/or ethers.

11. The non-aqueous electrolyte according to claim 9, wherein the aprotic organic solvent includes cyclic carbonate and chain carbonate.

12. The non-aqueous electrolyte according to claim 11, wherein the cyclic carbonate includes ethylene carbonate and/or propylene carbonate.

13. The non-aqueous electrolyte according to claim 11, wherein the chain carbonate includes diethyl carbonate, ethyl methyl carbonate, and/or dimethyl carbonate.

14. The non-aqueous electrolyte according to claim 8, wherein the electrolytic salt comprises a lithium salt.

15. The non-aqueous electrolyte according to claim 14, the lithium salt is one selected from the group consisting of LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, LiN(FSO₂)₂, and mixtures thereof.

16. The non-aqueous electrolyte according to claim 15, the lithium salt is LiPF₆.

17. The non-aqueous electrolyte according to claim 1,
wherein an amount of the compound represented by Chemical Formula (1) is 0.05 parts by mass to 20 parts by mass on a basis of an entire non-aqueous electrolyte being 100 parts by mass.

18. The lithium-ion secondary battery according to claim 4, wherein the lithium-ion secondary batter has a Capacity Retention Rate After 100 Cycles of 70% or higher.

19. The lithium-ion secondary battery according to claim 19, wherein the lithium-ion secondary batter has the Capacity Retention Rate After 100 Cycles of 80% or higher.

20. The lithium-ion secondary battery according to claim 19, wherein the lithium-ion secondary batter has the Capacity Retention Rate After 100 Cycles of 90% or higher.
